(19) United States
(12) Patent Application Publication
(10) Pub. No.: US 2010/0269409 A1
(43) Pub. Date: Oct. 28, 2010

(54) Tray for hydroponics growing of plants and hydroponics tank having the tray

(76) Inventor: Paul Johnson, Perth (AU)

Correspondence Address: PAUL JOHNSON;C/O KELVIN ROEHR, Level 1, 8 KING'S PARK ROAD, WEST PERTH, PERTH, WA, 6005, AU

(21) Appl. No.: 12/213,168

(22) Filed: Jun. 16, 2008

(51) Int. Cl. A01G 31/02

(52) U.S. Cl. 47/62 N

(57) ABSTRACT

A hydroponics tray (10) comprising a receptacle portion (12) bounded by a peripheral wall (14) which terminates in an upper peripheral rim (16), the receptacle portion (12) defining a plant support portion (24) having a first end (32) and a second end (34), a first reservoir (18) disposed adjacent the first end (32) and a second reservoir (20) disposed adjacent the second end (34), the first and second reservoirs (18,20) adapted to supply mineral nutrient solution (80) to the plant support portion (24), wherein in use, the plant support portion first end (32) is higher than the second end (34) such that when the first reservoir (18) supplies solution (80) from the first end (32) the solution runs to the second end (34) and when the second reservoir (20) supplies solution (80) from the second end (34) the plant support portion (24) is substantially filled with solution (80).

### FIELD OF THE INVENTION

the present invention relates to a tray for hydroponics growing of plants and to a hydroponics tank having the tray.

### BACKGROUND OF THE INVENTION

Hydroponics is the growing and producing of crops using mineral nutrient to solutions instead of soil. Plants are grown with their roots in the mineral nutrient solution only or in a medium, such as perlite, gravel or rockwool where mineral nutrient solution is supplied to the medium.

There are many different hydroponics growing techniques, such as wick, water culture, ebb and flow (flood & drain), drip (recovery or non-recovery), NFT (nutrient film technique) and aeroponics. Most available hydroponics growing assemblies have been designed for specific use of only of one of these techniques.

It is desirable to provide a hydroponics assembly which can be adapted for use with at least two different techniques to provide the user with choice and flexibility. It is the object of the present invention to achieve this desire or at least provide a useful alternative.

### SUMMARY OF THE INVENTION

The present invention provides a hydroponics assembly comprising a tray and at least one reservoir, the tray comprising a plant support portion having a first end and a second end, wherein in use, the first end is higher than the second end, the at least one reservoir adapted to supply mineral nutrient solution to the plant support portion, wherein the at least one reservoir can selectively supply solution from the first end at which the solution runs to the second end or from the second end at which the plant support portion is substantially filled with solution.

Preferably, the assembly includes a first reservoir for supplying solution to the tray first end and a second reservoir for supplying solution to the tray second end. The first reservoir is preferably disposed adjacent the plant support portion first end and the second reservoir is disposed adjacent the plant support portion second end.

The first reservoir is preferably separated from the plant support portion by a first barrier having openings therein such that solution in the first reservoir above the level of the openings can pour into the plant support portion. Preferably, the first barrier openings are at a predetermined level above a platform of the plant support portion.

The second reservoir is preferably separated from the plant support portion by a second barrier having openings therein such that solution in the second reservoir above the level of the openings can pour into the plant support portion. Preferably, the second barrier openings are substantially at the same level as a platform of the plant support portion.

The platform at the tray second end preferably includes a stepped down portion and the second barrier openings are at substantially the same level as the stepped down portion. The first and second reservoirs are preferably integrally formed with the tray.

The assembly preferably further includes a sump for containing mineral nutrient solution, the sump adapted to supply solution to the at least one reservoir. The sump preferably includes a pump for supplying solution to the at least one reservoir.

The tray is preferably integrally formed and includes a receptacle portion having the plant support portion and the at least one reservoir, the receptacle portion bounded by a peripheral wall which terminates in an upper peripheral rim. The upper rim is preferably curved to have a substantially inverted U shape.

In another aspect, the present invention provides a hydroponics tray comprising a receptacle portion bounded by a peripheral wall which terminates in an upper peripheral rim, the receptacle portion defining a plant support portion having a first end and a second end, a first reservoir disposed adjacent the first end and a second reservoir disposed adjacent the second end, the first and second reservoirs adapted to supply mineral nutrient solution to the plant support portion, wherein in use, the plant support portion first end is higher than the second end such that when the first reservoir supplies solution from the first end the solution runs to the second end and when the second reservoir supplies solution from the second end the plant support portion is substantially filled with solution.

The first reservoir is preferably separated from the plant support portion by a first barrier having openings therein such that solution in the first reservoir above the level of the openings can pour into the plant support portion. The first barrier openings are preferably at a predetermined level above a platform of the plant support portion.

The second reservoir is preferably separated from the plant support portion by a second barrier having openings therein such that solution in the second reservoir above the level of the openings can pour into the plant support portion. The second barrier openings are preferably substantially at the same level as a platform of the plant support portion. The second end preferably includes a stepped down portion and the second barrier openings are at substantially the same level as the stepped down portion. The tray is preferably integrally formed.

The present invention also provides a hydroponics assembly comprising the tray of the above further including a sump for containing mineral nutrient solution, the sump adapted to selectively supply solution to the first and second reservoirs. The sump preferably includes a pump for supplying solution to the first and second reservoirs.

The present invention in another aspect provides a hydroponics tank assembly comprising a container having an open top and a tray for substantially covering the open top of the container, the tray substantially spaced from the container bottom wall in use to form a sump therebetween for holding mineral nutrient solution, the tray comprising a plant support portion having a first end and a second end, the tank assembly further comprising a first reservoir disposed adjacent the first end and a second reservoir disposed adjacent the second end, the first and second reservoirs adapted to supply mineral nutrient solution from the sump to the plant support portion, wherein in use, the plant support portion first end is higher than the second end such that when the first reservoir supplies solution from the first end the solution runs to the second end and when the second reservoir supplies solution from the second end the plant support portion is substantially filled with solution.

The first reservoir is preferably separated from the plant support portion by a first barrier having openings therein at a predetermined level above a platform to of the plant support portion such that solution in the first reservoir above the level of the openings can pour into the plant support portion, and the second reservoir is separated from the plant support portion by a second barrier having openings therein at the same level as the platform of the plant support portion such that solution in the second reservoir above the level of the openings can pour into the plant support portion.

The platform at the second end preferably includes a stepped down portion and the second barrier openings are at substantially the same level as the stepped down portion.

The openings of the first barrier are preferably generally aligned with openings of the second barrier. The spaced parallel ribs are preferably formed on the top surface of the platform, the ribs extending between the first and second ends.

Preferably, the tray includes an upper rim which is supported by an upper rim of the container in use.

### BRIEF DESCRIPTION OF THE DRAWINGS

Preferred forms of the present invention will now be described by way of example only with reference to the accompanying drawings wherein:

FIG. 1 shows a tray for the hydroponics tank according to a preferred embodiment of the present invention, where (a) shows a top view, (b) shows a longitudinal cross-sectional view, (c) shows a cross-sectional view along line c-c of (b), and (d) shows a cross-sectional view along line d-d of (b);

FIG. 2 shows a container for the hydroponics tank according to the preferred embodiment, where (a) shows a side view, (b) shows an end view, and (c) shows a bottom view;

FIG. 3 shows the assembled hydroponics tank with the tray of FIG. 1 received in the container of FIG. 2, where (a) shows a top view, (b) shows a longitudinal cross-sectional view, (c) shows a cross-sectional view along c-c of (b), and (d) shows a cross-sectional view along line d-d of (b);

FIG. 4 shows a perspective view of the assembled hydroponics tank of FIG. 3;

FIG. 5 schematically shows three methods of use of the hydroponics tank, where (a) shows use of nutrient fill technique (NFT), (b) shows ebb and flow technique and (c) shows run to waste (RTW) technique.

### DETAILED DESCRIPTION OF THE PREFERRED EMBODIMENTS

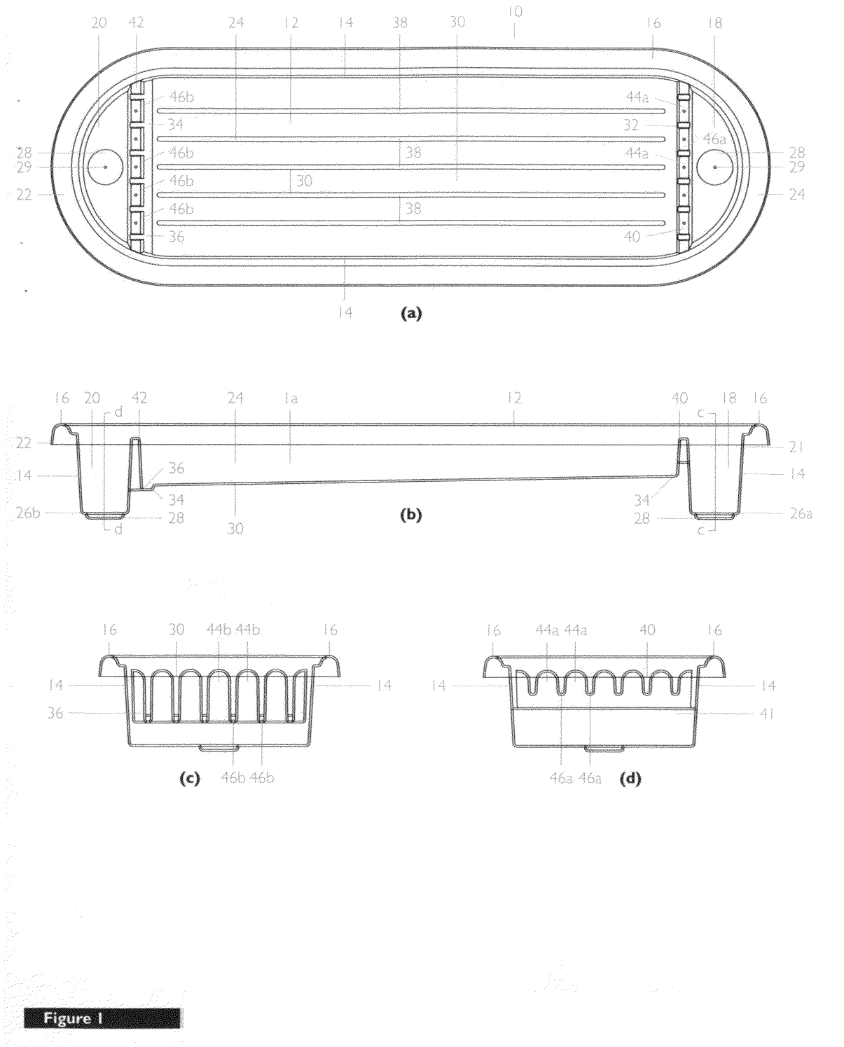

FIG. 1 shows an elongated tray 10 for a hydroponics tank according to a preferred embodiment of the present invention. The tray 10 includes a receptacle portion 12 bounded by a peripheral wall 14 which terminates in an upper peripheral rim 16. The upper rim 16 is curved to have a substantially inverted U shape. The receptacle portion 12 is generally divided into three sections being a first reservoir 18 at a first end 21 of the tray 10, a second reservoir 20 at a second end 22 of the tray 10 and a plant support portion 24 extending therebetween.

The first and second reservoirs 18 and 20 are substantially identical and include bottom walls 26a and 26b, respectively. Each bottom wall 26a and 26b has a central circular recess 28 with an aperture 29 formed therein, the purposes of which will be described below.

The plant support portion 24 includes a substantially flat platform 30 having a first end 32 adjacent the first reservoir 18 and a second end 34 adjacent the second reservoir 20. The platform first end 32 is closer to the upper rim 16 than the platform second end 34. As a result, the platform 30 is angled when the tray is in use, with the first end 32 being higher than the second end 34 as will be explained further below. The second end 34 further includes a stepped down portion 36 the purpose of which is also explained below. As a whole, the platform 30 is closer to the upper rim 16 than the bottom walls 26a and 26b of the first and second reservoirs 18 and 20. Spaced parallel ribs 38 are formed on the top surface of the platform 30, the ribs 38 extending between the first and second ends 32 and 34.

The plant support portion 24 is substantially separated from the first reservoir 18 by a first barrier 40 and from the second reservoir 20 by a second barrier 42. The first barrier 40 comprises a wall 41 which includes a number of alternating spaced peaks 44a and spaced openings 46a in the form of gullies between the peaks 44a. The lowest level of the openings 46a is at a predetermined distance above the platform 30 of the plant support portion 24. The second barrier 42 is similar to the first barrier 40 and includes spaced peaks 44b with spaced openings 46b between the peaks 44b. However, the lowest level of the openings 46b are at the same level as the stepped down portion 36 of the platform 30. This results in the peaks 44b substantially being formed as spaced individual panels. As shown in FIG. 1(a), each opening 46a is formed to be substantially aligned with an opening 46b, with each pair of openings 46a and 46b generally aligned with a space between two of the ribs 38.

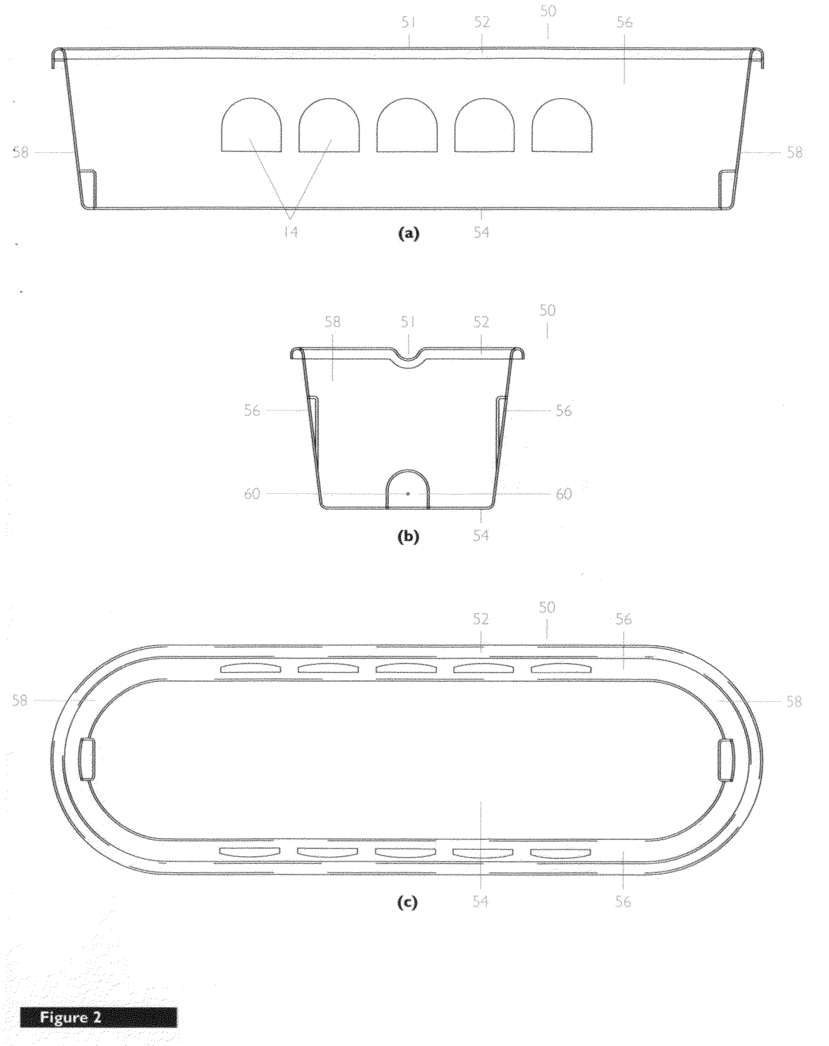

FIG. 2 shows an open top container 50 for the hydroponics tank of the preferred embodiment. The container 50 includes an open top 51, upper peripheral rim 52, a bottom wall 54, tapered side walls 56 and tapered end walls 58. The side walls 56 include a number of spaced recesses 59 formed therein for strengthening same. The end walls 58 each include a similar recess 59 disposed adjacent the bottom wall 54. Each end wall recess 59 has an aperture 60 formed therein which is closed by a plug (not shown). The upper rim 52 is curved to have a substantially inverted U shape, corresponding to the shape of the tray upper rim 16. The container 50 is dimensioned to receive the tray 10 and support same via engagement of the upper rims 16 and 52 as explained below.

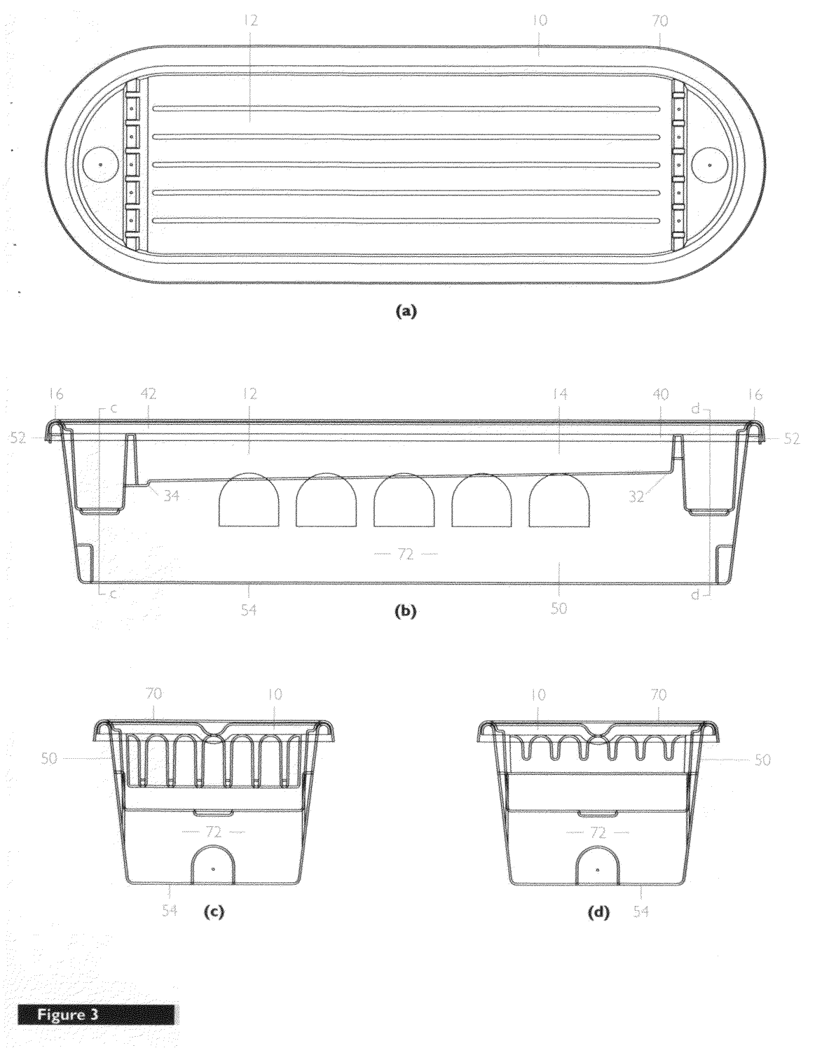

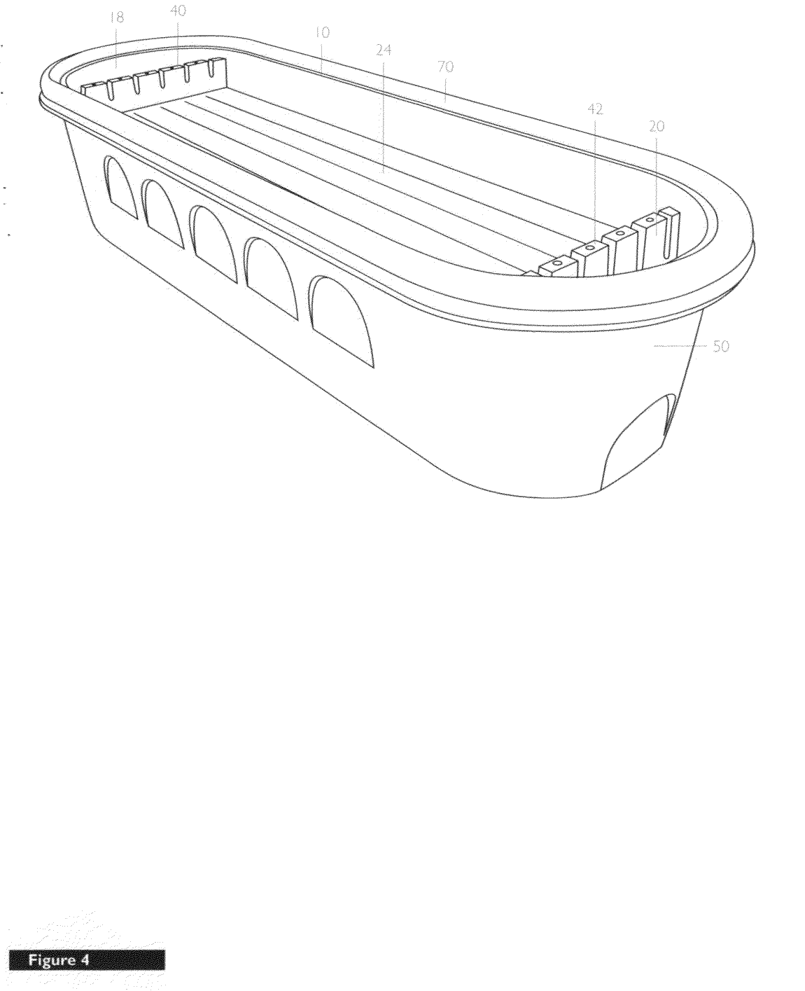

FIGS. 3 and 4 show an assembled hydroponics tank 70 with the tray 10 received in the container 50. The tray upper rim 16 is supported by the container upper rim 52 such that the tray receptacle portion 12 is spaced from the container bottom wall 54, forming a sump 72 therebetween. In the assembled tank 70, the platform 30 is angled with its first end 32 higher than its second end 34. The tray 10 thus covers the open top 51 of the container 50.

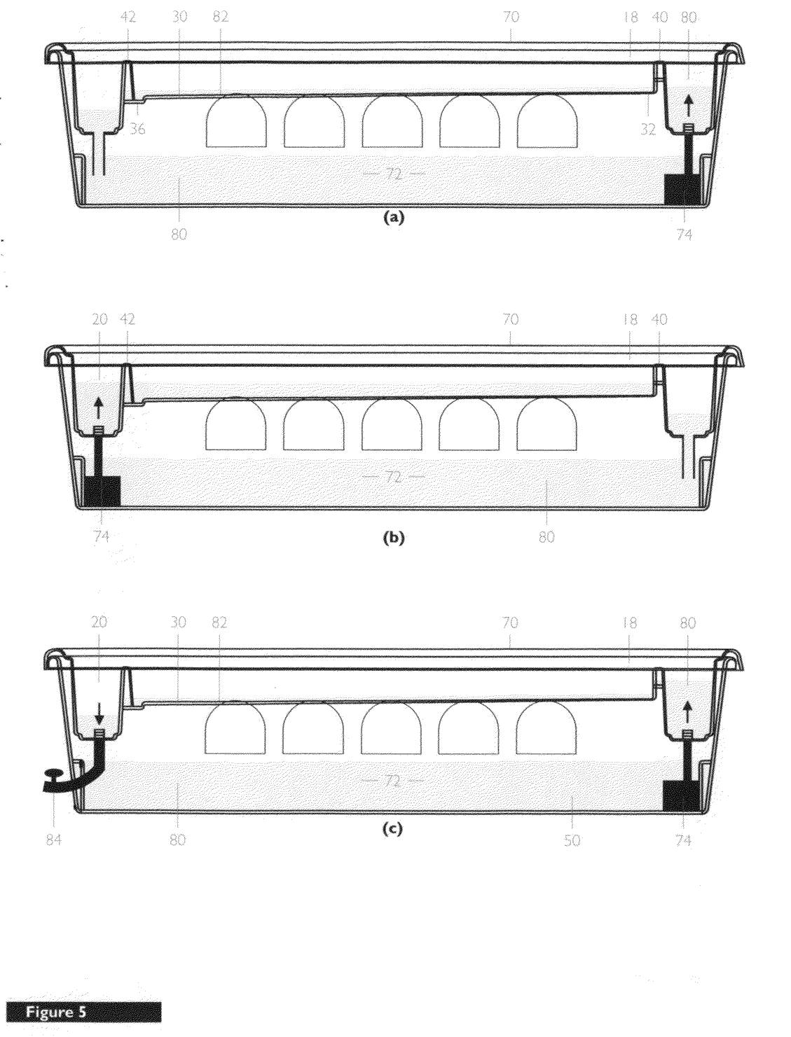

FIG. 5(a) to (c) show three methods of use of the hydroponics tank. In use, a growing medium (not shown) is laid onto the platform 30 substantially up to the level of the platform upper rim 16. The growing medium is retained therein by the tray elongated side walls 14 and the first and second barriers 40 and 42. Plants can then be planted into the growing medium with mineral nutrient solution supplied to the growing medium via the barrier openings 46a or 46b by one of the techniques explained below.

FIG. 5(a) shows a first method of use of the hydroponics tank 70 using nutrient film technique (NFT). In NFT, the sump 72 is filled with mineral nutrient solution 80. A pump 74 is connected to the recess aperture 29 of the first reservoir 18. In use, solution 80 is pumped by the pump 74 into the first reservoir 18. The first reservoir 18 is continued to be filled with solution 80 until the solution level in the first reservoir 18 rises above the openings 46a of the first barrier 40. Solution 80 then pours through the openings 46a onto the platform 30, with the solution 80 traveling from the platform first end 32 toward the stepped down portion 36 at the platform second end 34 due to the angle of the platform 30. At the second end 36, the solution 80 is drained via the openings 46b of the second barrier 42 into the second reservoir 20 which is drained back into the sump 72 via the aperture 29 in the second reservoir 20. The central circular recess 28 in the second reservoir 20 assists to ensure that all solution 80 therein is drained into the sump 72.

The raised ribs 38 on the platform 30 and the positioning of the openings 46a between the ribs 38 substantially ensure that solution 80 is generally evenly distributed along the width of the platform 30 for movement toward the platform second end 34. This provides a thin layer 82 of mineral nutrient solution 80 along the width and length of the platform 30 which is absorbed or retained by the growing medium for the roots of the plants in the tray 10. The pumping rate and pumping time of the pump 74 is controlled to provide the thin layer 82 of solution 80 as desired and required. The stepped down portion 36 in the platform second end 34 assists in further ensuring that the solution 80 travels towards the second end 34, as well as ensuring that all solution 80 will be drained from the platform 30 when the pump 74 is switched off.

FIG. 5(b) shows a second method of use of the hydroponics tank 70 using the ebb and flow technique. In this technique, the pump 74 in the sump 72 is connected to the aperture 29 in the recess 28 of the second reservoir 20. Solution 80 is pumped into the second reservoir 20 and the solution liquid level rises and flows onto the platform 30 via the openings 46b of the second barrier 42. Solution 80 is continued to be pumped until the platform 30 is substantially filled and solution 80 overflows into the first reservoir 18 via the first barrier openings 46a. Solution 80 in the first reservoir 18 can then drain back into the sump 72 via the aperture 29 in the first reservoir 18. A timer (not shown) can be used for the pump 74 to control the flooding time of the platform 30. For example, the platform 30 can be flooded for a predetermined period and then the pump 74 can be switch off to allow solution 80 to drain back into the sump 72 via the second reservoir aperture 29.

FIG. 5(c) shows a third method of use of the hydroponics tank 70 using the run to waste (RTW) technique. RTW is similar to NFT in that the pump 74 is connected to the first reservoir 18. Solution 80 is pumped into the first reservoir 18 to form a solution film 82 in the platform 30 as with NFT. In RTW however, the aperture 29 in the second reservoir 20 connected to a tube 84 for draining the solution 80 out of the container 50. The tube 84 extends through the aperture 60 in the end wall recess 59.

In all of the above methods, a controller (not shown) can be used to control the pumping rate of the pump 74. The controller can also include a timer for controlling the length of time of operation of the pump 74. This allows control of how much nutrient is delivered to the plants.

By lifting the tray from the container 50, the user can easily see the solution level in the container 50, as well as adjusting properties of the solution as required. In an alternative embodiment, a portion of the tray 10 can include an access aperture which will allow a dip or sampling stick to extend therethrough from the sump 72, which will allow the user to assess water lever as well as composition of the solution 80.

Both the tray 10 and container 50 are preferably made from High Density Polyethylene (HDPE) material, moulded as separate single pieces. Other suitable materials include plastics materials, such as Phenylene Ether Co-polymer (PPE) and Polyethylene (PE), or metal material such as stainless steel.

Although preferred embodiments of the present invention have been described, it will be apparent to skilled persons that the invention can be embodied in other forms or that modifications can be made to the above embodiments. For example, the first and second barriers 40 and 42 in one form can be described as a raised sluice section comprising a series of merlons and parapets. The barriers 40 and 42 for example can be replaced by perforated panels, screens or sponges. However, the present embodiment described above is preferred due to its durability and relatively low cost. In another embodiment, the openings 46a and 46b of the first and second barriers 18 and 20 can be spaced apertures in the barriers, instead of gullies as described. In this embodiment, the peaks 44a and 44b will be joined to each other.

Further, the tray 10 and container 50 can be made as a single piece, with the pump 74 selectively attachable to the first or second reservoir 18 or 20 via a valve switch. A separate tray is however preferred for convenience. In another alternative embodiment, the first and second reservoirs 18 and 20 can form part of the container 50, with the tray 19 only having the plant support section 24.

The hydroponics tank 70 can also be used with other known hydroponics techniques such as a wick system or drip system (by installing wick tubes or drip tubes along the platform 30 within or on top of the growing medium and connecting the tubes to the pump 74), as a water culture system (by forming apertures in the tray 10 for the plant roots to extend into the sump 72) or as an aeroponics system (by forming apertures in the tray 10 for the plant roots to extend into the sump 72 and installing a solution mister in the sump 72). A number of different mediums can be used with the hydroponics tank 70 such as rock wool, coco-coir, expanded clay balls and perlite. The hydroponics tank 70 thus provides more flexibility and choice for the user.

1. A hydroponics assembly comprising a tray and at least one reservoir, the tray comprising a plant support portion having a first end and a second end, wherein in use, the first end is higher than the second end, the at least one reservoir adapted to supply mineral nutrient solution to the plant support portion, wherein the at least one reservoir can selectively supply solution from the first end at which the solution runs to the second end or from the second end at which the plant support portion is substantially filled with solution.

2. The assembly of claim 1 wherein the assembly includes a first reservoir for supplying solution to the tray first end and a second reservoir for supplying solution to the tray second end.

3. The assembly of claim 2 wherein the first reservoir is disposed adjacent the plant support portion first end and the second reservoir is disposed adjacent the plant support portion second end.

4. The assembly of claim 2 or 3 wherein the first reservoir is separated from the plant support portion by a first barrier having openings therein such that solution in the first reservoir above the level of the openings can pour into the plant support portion.

5. The assembly of claim 4 wherein the first barrier openings are at a predetermined level above a platform of the plant support portion.

6. The assembly of any one of claims 2 to 5 wherein the second reservoir is separated from the plant support portion by a second barrier having openings therein such that solution in the second reservoir above the level of the openings can pour into the plant support portion.

7. The assembly of claim 6 wherein the second barrier openings are substantially at the same level as a platform of the plant support portion.

8. The assembly of claim 7 wherein the platform at the tray second end includes a stepped down portion and the second barrier openings are at substantially the same level as the stepped down portion.

9. The assembly of any one of claims 2 to 7 wherein the first and second reservoirs are integrally formed with the tray.

10. The assembly of any one of claims 1 to 9 further including a sump for containing mineral nutrient solution, the sump adapted to supply solution to the at least one reservoir.

11. The assembly of any one of claims 1 to 10 wherein the sump includes a pump for supplying solution to the at least one reservoir.

12. The assembly of any one of claims 1 to 11 wherein the tray is integrally formed and includes a receptacle portion having the plant support portion and the at least one reservoir, the receptacle portion bounded by a to peripheral wall which terminates in an upper peripheral rim.

13. The assembly of claim 12 wherein the upper rim is curved to have a substantially inverted U shape.

14. A hydroponics tray comprising a receptacle portion bounded by a peripheral wall which terminates in an upper peripheral rim, the receptacle portion defining a plant support portion having a first end and a second end, a first reservoir disposed adjacent the first end and a second reservoir disposed adjacent the second end, the first and second reservoirs adapted to supply mineral nutrient solution to the plant support portion, wherein in use, the plant support portion first end is higher than the second end such that when the first reservoir supplies solution from the first end the solution runs to the second end and when the second reservoir supplies solution from the second end the plant support portion is substantially filled with solution.

15. The tray of claim 14 wherein the first reservoir is separated from the plant support portion by a first barrier having openings therein such that solution in the first reservoir above the level of the openings can pour into the plant support portion.

16. The tray of claim 15 wherein the first barrier openings are at a predetermined level above a platform of the plant support portion.

17. The tray of any one of claims 14 to 16 wherein the second reservoir is separated from the plant support portion by a second barrier having openings therein such that solution in the second reservoir above the level of the openings can pour into the plant support portion.

18. The tray of claim 17 wherein the second barrier openings are substantially at the same level as a platform of the plant support portion.

19. The tray of claim 18 wherein the platform at the second end includes a stepped down portion and the second barrier openings are at substantially the same level as the stepped down portion.

20. The tray of any one of claims 14 to 19 wherein the tray is integrally formed.

21. A hydroponics assembly comprising the tray of any one of claims 14 to 20 further including a sump for containing mineral nutrient solution, the sump adapted to selectively supply solution to the first and second reservoirs

22. The assembly of claim 21 wherein the sump includes a pump for supplying solution to the first and second reservoirs.

23. A hydroponics tank assembly comprising a container having an open top and a tray for substantially covering the open top of the container, the tray substantially spaced from the container bottom wall in use to form a sump therebetween for holding mineral nutrient solution, the tray comprising a plant support portion having a first end and a second end, the tank assembly further comprising a first reservoir disposed adjacent the first end and a second reservoir disposed adjacent the second end, the first and second reservoirs adapted to supply mineral nutrient solution from the sump to the plant support portion, wherein in use, the plant support portion first end is higher than the second end such that when the first reservoir supplies solution from the first end the solution runs to the second end and when the second reservoir supplies solution from the second end the plant support portion is substantially filled with solution.

24. The tank assembly of claim 23 wherein the first reservoir is separated from the plant support portion by a first barrier having openings therein at a predetermined level above a platform of the plant support portion such that solution in the first reservoir above the level of the openings can pour into the plant support portion, and the second reservoir is separated from the plant support portion by a second barrier having openings therein at the same level as the platform of the plant support portion such that solution in the second reservoir above the level of the openings can pour into the plant support portion.

25. The tank assembly of claim 24 wherein the platform at the second end includes a stepped down portion and the second barrier openings are at substantially the same level as the stepped down portion.

26. The tank assembly of claim 24 or 25 wherein the openings of the first barrier are generally aligned with openings of the second barrier.

27. The tank assembly of any one of claims 24 to 26 wherein spaced parallel ribs are formed on the top surface of the platform, the ribs extending between the first and second ends.

28. The tank assembly of any one of claims 24 to 27 wherein the tray includes an upper rim which is supported by an upper rim of the container in use.

29. A hydroponics assembly substantially as herein described with reference to the accompanying drawings.

30. A hydroponics tray substantially as herein described with reference to the accompanying drawings.

31. A hydroponics tank assembly substantially as herein described with reference to the accompanying drawings.
